(19) United States
(12) Patent Application Publication
(10) Pub. No.: US 2016/0166101 A1
(43) Pub. Date: Jun. 16, 2016

(54) FUSED WINDOW SHIELD

(71) Applicant: Hong Xu Kinsey, San Jose, CA (US)

(72) Inventor: Hong Xu Kinsey, San Jose, CA (US)

(21) Appl. No.: 14/749,404

(22) Filed: Jun. 24, 2015

Related U.S. Application Data
(63) Continuation-in-part of application No. 14/716,770, filed on May 19, 2015.
(60) Provisional application No. 62/017,104, filed on Jun. 25, 2014.

(51) Int. Cl. A47H 23/10; B29C 65/02; B29C 65/00; A47H 23/14

(52) U.S. Cl. CPC A47H 23/10; A47H 23/14; B29C 65/02; B29C 66/45; B29K 2067/00

(57) ABSTRACT

A window shield with a decorative layer bonded/fused with a functional layer. The functional layer comprises materials and/or constructions that can block heat, light, and/or noise from penetrating through the window shield.

### CROSS-REFERENCE TO RELATED APPLICATION(S)

This application is a continuation-in-part of the U.S. patent application Ser. No. 14/716,770, filed May 19, 2015 and titled, “INSTANT SWAPPABLE CURTAINS” and claims priority under 35 U.S.C. §119(e) of the U.S. Provisional Patent Application Ser. No. 62/017,104, filed Jun. 25, 2014 and titled, FUSED WINDOW SHIELD,” which are also hereby incorporated by reference in their entirety for all purposes.

### FIELD OF THE INVENTION

The present invention relates to the field of home decor. More specifically, the present invention relates to functional curtains.

### BACKGROUND OF THE INVENTION

Typical curtains shield lights from coming into the buildings or rooms. However, the typical curtains do not provide a good barrier for efficiently preventing heat from entering the building.

### SUMMARY OF THE INVENTION

A window shield with decorative fabrics fused with functional fabrics. Other features and advantages of the present invention will become apparent after reviewing the detailed description of the embodiments set forth below.

The constructions of the fabrics and the method of making the same make the fabrics/clothes disclosed herein possess the function of lights and sounds blocking/shielding, which provides the functions of energy saving and which also can be used as a green product.

The fabrics disclosed herein can be used to make window shields, curtains, window screens, wearable clothes and pants, among other fabric products. Such advanced features allow the consumers and designers to have more choices in terms of functionality of the window shields.

In a aspect, a window shield comprises a first layer and a second layer fused or bonded with the first layer, wherein the second layer comprises a first amount of white threads substantially perpendicular to a second amount of black threads. In some embodiments, the window shield comprises a third amount of white threads parallel to the second amount of the black threads. In other embodiments, the second amount of the black threads and the third amount of the white threads jointly form the entire threads of a direction of the window shield. In some other embodiments, the second amount of the black threads comprises no less than 45% of the threads in one direction. In some embodiments, the second amount of the black threads comprises 20%-85% of the threads in one direction. In other embodiments, the second amount of the black thread is in a percentage sufficient to block at least 90% of lights. In some other embodiments, the second amount of the black threads are horizontal threads.

In another aspect, a curtain comprises a decorative layer and a functional layer covers the decorative layer, wherein the functional layer comprises an amount of black threads blocking at least 90% of incoming sunlights. In some embodiments, the functional layer comprises at least 45% of black threads coupling with white threads. In other embodiments, the black threads are horizontal threads. In some other embodiments, a weight per square meter of the functional layer is between 100 g/m² and 230 g/m². In some other embodiments, the decorative layer is bonded or fused with the functional layer. In some embodiments, the decorative layer is bonded or fused with the functional layer via a layer of meltable fiber.

In another aspect, a method of making a window shield comprises coupling a decorative layer with a functional layer, heating a fusible material layer at a predetermined temperature, bonding or fusing the decorative layer with the functional layer through a melting of the fusible material layer. In some embodiments, the functional layer comprises an amount of black threads. In other embodiments, the black threads are horizontal threads. In some other embodiments, the black threads comprise at least 45% of a weight of the window shield. In some embodiments, the black threads are in one or more zones of the window shield.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIGS. 1A and 1B illustrate window shields in accordance with some embodiments of the present invention.

FIG. 2 illustrates window shields in various constructions in accordance with some embodiments of the present invention.

FIG. 3 is a flow chart illustrating a method of making a window shield in accordance with some embodiments of the present invention.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

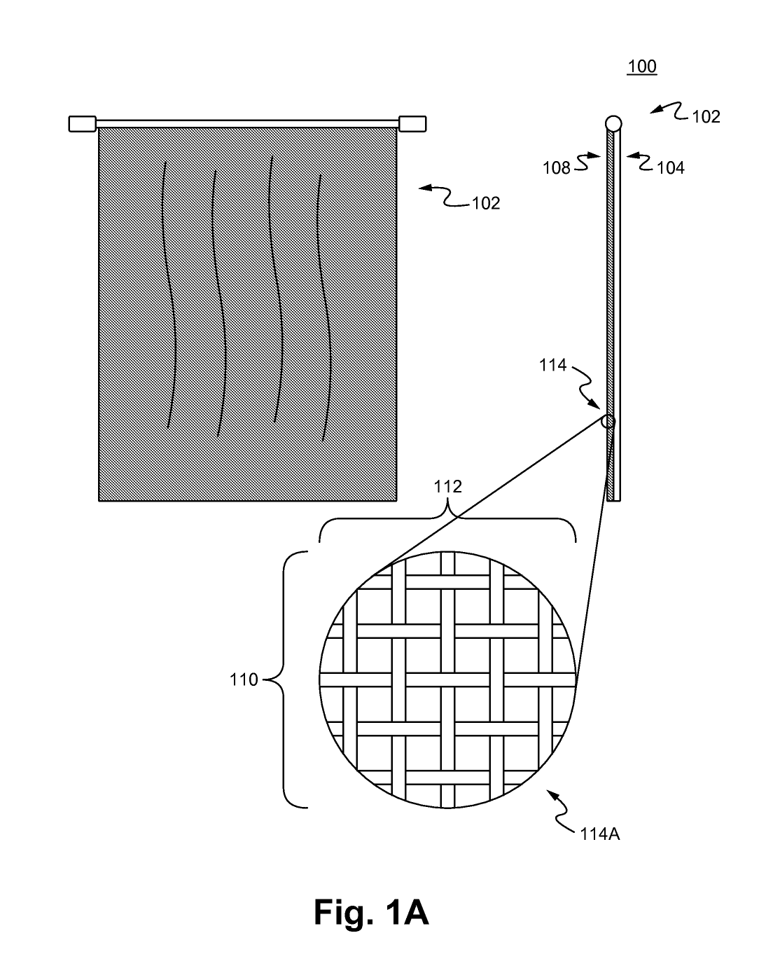

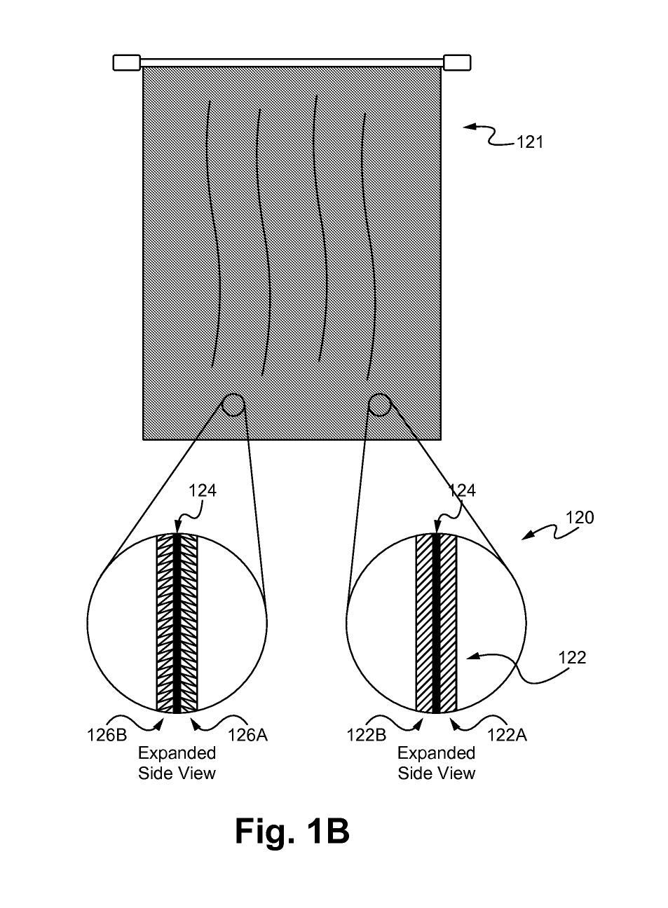

FIGS. 1A and 1B illustrate a window shield 100 in accordance with some embodiments of the present invention. The window shield 100 contains a fabric body 102. The body 102 comprises a decorative face fabric 104 fused and/or bonded with a functional fabric 108. In some embodiments, the decorative face fabric 104 is used to face the user and/or indoor and the functional fabric 108 is used to face the sunlight side and/or window.

An expanded view 114A illustrates a construction 114 of the functional fabric 108. In some embodiments, the construction 114 is formed by combining horizontal threads 110 and vertical threads 112 via weaving, sewing, knitting, or any other methods that can be used to form/spun thread for making a layer of cloth. In some embodiments, the term thread used herein can comprise yarns, cotton, polymers, fiber, filament, nylon, or any other elongated members that can be combined to form the layer of cloth.

In some embodiments, a weight per square meter of the functional fabric 108 is 100 g/m² or higher. In some embodiments, a weight per square meter of the functional fabric 108 is between 100 g/m² and 230 g/m².

In some embodiments, the vertical threads 112 contain 86 g/m² of white thread and the horizontal threads 110 contain 45% (68 g/m²) of black thread mixing with 55% of white thread. The functional fabric 108 fused and/or bonded with the decorative face fabric 104 is able to serve as a green/energy saving curtain, which shields/isolates 97%-99% of lights and noises/sounds.

In some embodiments, the white threads and black threads are polyester threads. In some embodiments, the black threads serve as a black body, which absorbs heat when a temperature of the environment is high or when the sunlight is abundant. The black threads release heat when the temperature or sunlight goes down. In some embodiments, the construction 114 shifts the heat leasing time to a time with a lower environmental temperature providing a function of heat releasing time-shift/delay function. In some embodiments, the ratio of the black threads in the construction 114 can range from 1% to 99%. For example, the black thread is from 10%-30%. In another example, the black thread is from 51%-80%. In another example, the black thread is 50%.

In some embodiments, the decorative face fabric 104 is a plain weave, a dobby texture, or a fashion jacquard material. The decorative face fabric 104 can be any other decorative fabrics/materials that people use to decorate their home.

In some embodiments, the functional fabric 108 comprises a satin weave blackout construction fabric. In some embodiments, the satin weave blackout construction fabric comprises a warp yarn in a white yarn and a weft yarn in a black yarn.

In other embodiments, the functional fabric 122 comprises a triple weave blackout construction 120 (FIG. 1B), which comprises both face side 122A and back side 122B in a satin weave (warp) and a middle part with a black yarn (weft).

The bonding/fusing of the curtains 100 and 121 can be achieved by using a fusing material 124, which is sandwiched by the decorative face fabric 126B and the functional fabric 126A. In some embodiments, the fusing material 106 comprises a fusible web, which can be an artificial/manmade fiber that melts when heated with a predetermined temperature. When the fusing material 124 is placed between two pieces of fabrics (such as the decorative face fabric 126B and the functional fabric 126A), the melting of the web causes it to fuse/couple the fabrics 126A and 126B together. The web can be non-woven or non-knitted. The fusible web can be in rolls, similar to a tape, and in various widths.

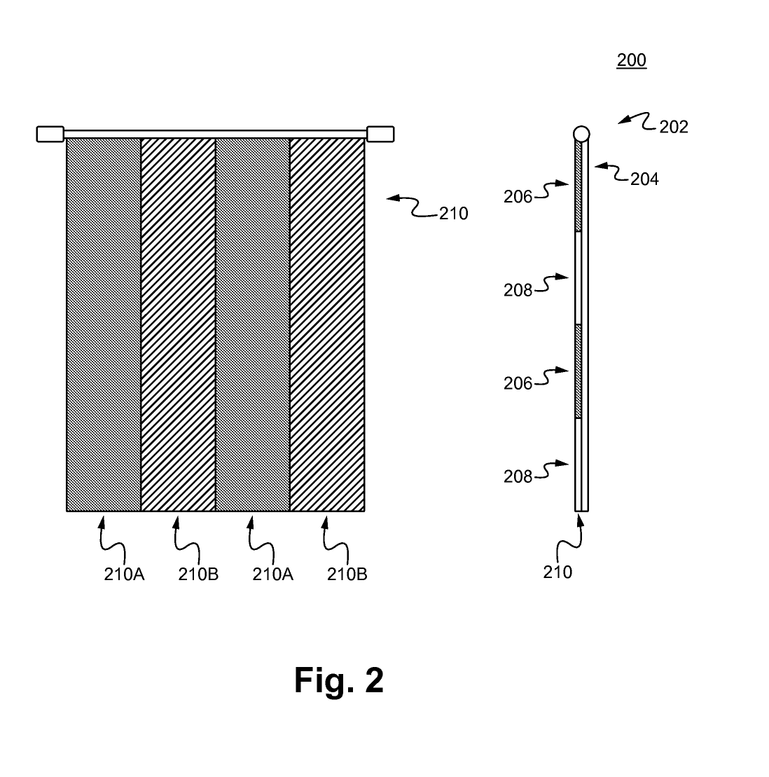

FIG. 2 illustrates window shields in various constructions 200 in accordance with some embodiments of the present invention. In some embodiments, a window shield 202 comprises a decorative layer 204 couples with a functional layer 210. In some embodiments, the functional layer 210 comprises different zones 206 and 208 having different materials or different physical properties in each or multiple of the zones. For example, the zone 206 can have a higher weight percentage or density than the zone 208, such as 200 g/m² and 108 g/m² respectively. In another example, the zone 206 comprises a polymeric material (such as polyester) and the zone 208 comprises 75% cotton and 25% polyester.

In some embodiments, a window shield 210 comprises decorative zones 210A couples with functional zones 210B jointly forming the entire surface of the window shield 210.

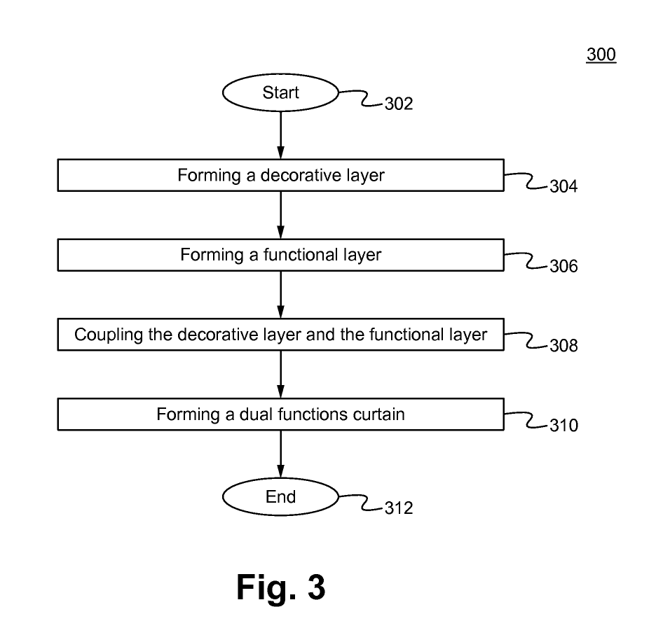

FIG. 3 is a flow chart illustrating a method of making a window shield in accordance with some embodiments of the present invention. The method 300 can start from a Step 302. At a Step 304, a decorative layer is formed. The decorative face fabric described herein can contain any patterns, graphic designs, and any other materials. At a Step 306, a functional layer is formed. The functional layer can comprise materials selected based on a predetermined material property. For example, when a function of UV light blocking is selected, a material that blocks UVA and UVB rays is selected, such as polyester/spandex fabric and stretchable poly/lycra fabric with a UV blocking polymer coating. At a Step 308, the decorative layer and the functional layer are coupled/bonded together. At a Step 310, a dual functions curtain is formed. The method 300 can stop at a Step 312.

The bonded window shield can be utilized in blocking light and heat from penetrating through the shield, such that the rooms inside the building can keep cool/warm while insulating and/or blocking the heat and light from outside. The bonded window shield can also be used to reduce noise by blocking or absorbing the noise.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims.

What is claimed is:

1. A window shield comprising:
a) a first layer; and
b) a second layer fused or bonded with the first layer, wherein the second layer comprises a first amount of white threads substantially perpendicular to a second amount of black threads.

2. The window shield of claim 1, wherein the window shield comprises a third amount of white threads parallel to the second amount of the black threads.

3. The window shield of claim 2, wherein the second amount of the black threads and the third amount of the white threads jointly form the entire threads of a direction of the window shield.

4. The window shield of claim 2, wherein the second amount of the black threads comprises no less than 45% of the second and third amounts of the threads.

5. The window shield of claim 2, wherein the second amount of the black threads comprises 20%-85% of the second and third amounts of the threads.

6. The window shield of claim 1, wherein the second amount of the black thread is in a percentage sufficient to block at least 90% of lights.

7. The window shield of claim 1, wherein the second amount of the black threads are horizontal threads.

8. A curtain comprising:
a) a decorative layer; and
b) a functional layer covers the decorative layer, wherein the functional layer comprises an amount of black threads blocking at least 90% of incoming sunlights.

9. The curtain of claim 8, wherein the functional layer comprises at least 45% of black threads coupling with white threads.

10. The curtain of claim 8, wherein the black threads are horizontal threads.

11. The curtain of claim 8, wherein a weight per square meter of the functional layer is between 100 g/m² and 230 g/m².

12. The curtain of claim 8, wherein the decorative layer is bonded or fused with the functional layer.

13. The curtain of claim 8, wherein the decorative layer is bonded or fused with the functional layer via a layer of meltable fiber.

14. A method of making a window shield comprising:
a) coupling a decorative layer with a functional layer;
b) heating a fusible material layer at a predetermined temperature;
c) bonding or fusing the decorative layer with the functional layer through a melting of the fusible material layer.

15. The method of claim 14, wherein the functional layer comprises an amount of black threads.

16. The method of claim 14, wherein the black threads are horizontal threads.

17. The method of claim 14, wherein the black threads comprise at least 45% of a weight of the window shield.

18. The method of claim 14, wherein the black threads are in one or more zones of the window shield.
